(19) United States
(12) Patent Application Publication
(10) Pub. No.: US 2009/0240624 A1
(43) Pub. Date: Sep. 24, 2009

(54) RISK DETECTION AND ASSESSMENT OF CASH PAYMENT FOR ELECTRONIC PURCHASE TRANSACTIONS

(75) Inventors: Sheila H. JAMES, Ottawa (CA); John A. MACMILLAN, Carp (CA); Radhika AGARWAL, Ottawa (CA); Marwan FORZLEY, Ottawa (CA); Samer FORZLEY, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: MODASOLUTIONS CORPORATION, Ottawa (CA)

(21) Appl. No.: 12/408,449

(22) Filed: Mar. 20, 2009

Related U.S. Application Data
(60) Provisional application No. 61/038,290, filed on Mar. 20, 2008.

(51) Int. Cl. G06Q 20/00

(52) U.S. Cl. 705/44

(57) ABSTRACT

A system and methods are provided which allow consumers to pay for ecommerce transactions through online bill payment and for merchants to determine that payments are not fraudulent. The system and methods do not rely on personal or confidential customer information relating to credit-cards and/or bank account routing information, date of birth and/or social security number. A risk manager can perform risk assessment for the cash payment based on order information and non-confidential purchaser information included in a cash payment request. In response to receiving an indication of the cash payment from the purchaser, a determination is made whether the cash payment is a good payment based on the risk assessment. The cash payment is released to a merchant in response to a determination that the cash payment is a good payment.

### CROSS REFERENCE TO RELATED APPLICATIONS

This application claims the benefit of priority of U.S. Provisional Patent Application No. 61/038,290 filed Mar. 20, 2008, which is incorporated herein by reference in its entirety.

### FIELD OF THE INVENTION

The present invention relates generally to payment processing. More particularly, the present invention relates processing of a cash payment, such as an online bill payment, for an electronic purchase transaction.

### BACKGROUND OF THE INVENTION

Online transactions are becoming prevalent as more and more people gain affordable access to the Internet. While some consumers are comfortable with the security provided when performing an online purchase and authorizing its associated payment transaction, others are not. Such transactions typically include transmission of credit card information, or other financial information. Some companies that have popularized electronic purchase transactions include eBay, Amazon.com and Buy.com.

In known online transactions, at the time that a purchase is made, the purchaser must provide credit card or other financial information to the merchant in order to provide the funds required to complete the transaction. This is typically provided in a “checkout” phase of the transaction. The credit card or other financial information is used to authorize the transaction, and is also used to perform risk detection and assessment.

Instead of providing such sensitive information for each transaction, a purchaser can set up an account with a merchant, and their sensitive information can be stored on a merchant's server. The purchaser can then log in to the account using authorization credentials, such as a username and password, and complete an electronic purchase transaction without transmitting sensitive information to the merchant. The merchant simply uses the purchaser's authorization credentials to authorize access to the credit card or other financial information associated with the purchaser's account. Even in the absence of requiring credit card or other financial information, some systems may require a user to provide their date of birth, social security number, or other sensitive data in order to authorize the transaction and/or perform risk detection and assessment for the transaction.

There have been some advances in terms of using online bill payments as a means for fulfilling an online purchase. An example of an electronic purchase transaction that can be fulfilled using a cash payment is the eBillme™ system from MODASolutions Corporation. Using the eBillme™ system, a customer can complete an online, or electronic, purchase transaction without having to transmit any sensitive banking or credit card information.

An electronic bill is then sent to the purchaser, such as by electronic mail, and the purchaser can pay the electronic bill after the order has been processed through his financial institution. The payment of such an electronic bill is referred to herein as a “cash payment” for an electronic purchase transaction. This cash payment can be made using secure and well-established online bill payment facilities. Alternatively, the cash payment can be made by a purchaser walking in to a retail location of a bank or other financial institution, by sending a cheque, wire transfer or money order, etc.

Today there are limitations for accepting online bill payments for ecommerce transactions, such as:

1. There is no way to provide real-time notification of payment. Payment notification of online bill payments on average can occur anywhere from 2 hrs to 10 business days after the payment has been made. Merchants must wait for payment notification prior to fulfilling the order which may result in holding inventory or risk not having inventory when the payment finally arrives.

2. There is no way to authorize an order and guarantee payment made through online bill payment without collecting sensitive payment or personal information.

3. There is no way to guarantee that a payment is not fraudulent coming from a compromised account

These limitations mean that there is no way for a merchant to know if the online payment is good. The term “good payment” as used herein refers to a payment for which the purchaser likely has sufficient funds and is not fraudulent.

Traditionally the online banking network was designed for people to pay their monthly bills like utilities and mortgage payments. Fraud is minimal in these cases as they are easily identified, caught, and halted (e.g. turn off utility) as the end user is “known”.

Using online banking to pay for goods purchased over the Internet creates a new avenue for fraud. Purchases can be made by fraudsters who have access to stolen account holder usernames/passwords and the goods can be shipped to fraudulent/transient addresses: PO Boxes, shipping companies, multi-tenant dwellings.

Existing online fraud detection tools rely on credit card, and/or date-of-birth, and/or social security number, and/or bank routing and account numbers to verify the identity of the user and to authorize transactions. The challenge is that online banking payments do not provide these pieces of information. For security reasons, online banking transactions block sensitive information such as: bank routing and account number and address of account holder, and personal information is not shared with the receiving parties during online banking bill payment transactions. However, these security features make it difficult for payment processors and merchants to determine the identity of the originator of the payment.

Therefore, it is desirable to provide a system and method to for risk detection and assessment for online bill payment transactions.

### SUMMARY OF THE INVENTION

It is an object of the present invention to obviate or mitigate at least one disadvantage of previous approaches for assessing and mitigating risk for online payments. An embodiment of the present invention provides an authorized cash payment system, in which risk detection and assessment is provided for a cash payment associated with an electronic purchase transaction.

In an aspect, fraud detection and risk management of cash payments are based on heuristic tools that can make a determination based on a combination of: receiving party category; order information; account holder name; and method of payment.

Previous attempts to solve risk for cash payments were not flexible enough for mass-market online retailers. A complete solution provides the ability to decline or authorize as quickly as possible.

In an aspect, the present invention provides a method of risk detection and assessment of a cash payment for an electronic purchase transaction, comprising: receiving, at a cash payment administration system, a cash payment request associated with the cash payment for the electronic purchase transaction, the request including order information and non-confidential purchaser information; performing, at a risk manager within the cash payment administration system, a risk assessment for the cash payment based on the order information and non-confidential purchaser information; in response to receiving an indication of receipt of the cash payment from the purchaser, determining, at the risk manager, whether the cash payment is a good payment based on the risk assessment; releasing the cash payment to a merchant in response to a determination that the cash payment is a good payment.

Performing the risk assessment can include determining a purchaser profile based on the received order information and non-confidential purchaser information. Determining whether the cash payment is a good payment can include comparing the determined purchaser profile to a stored trustworthy purchaser profile to determine if the purchaser is a trusted purchaser.

Performing the risk assessment can include determining accuracy of the received non-confidential purchaser information. Determining accuracy of the received non-confidential purchaser information can include initiating a comparison of the received non-confidential purchaser information with stored database information.

Determining whether the cash payment is a good payment can include determining whether the non-confidential purchaser information is fraudulent. Releasing the cash payment to the merchant can include applying the cash payment to the electronic purchase transaction.

The method can further include refunding the cash payment in response to a determination that the cash payment is not a good payment. The cash payment can be refunded to a financial institution from which the cash payment originated.

Determining whether the cash payment is a good payment can include verifying an account holder name associated with the cash payment. Determining whether the cash payment is a good payment can be based on a payment source associated with the cash payment.

Releasing the cash payment can be performed prior to receiving the cash payment and in response to a determination that the risk assessment is more positive than a stored low risk threshold.

In another aspect, the present invention provides a computer readable memory storing statements and instructions for execution by a computer to perform any of the methods described herein.

In a further aspect, the present invention provides a cash payment administration system for processing a cash payment for an electronic purchase transaction, the cash payment administration system being in communication with a merchant and with a financial institution. A merchant communications interface is arranged to receive, from the merchant, a cash payment request associated with the cash payment, the request including order information and non-confidential purchaser information. A risk manager is arranged to perform a risk assessment for the cash payment based on the order information and non-confidential purchaser information. A payment communications interface is arranged to receive an indication of receipt of the cash payment by the financial institution from the purchaser. The risk manager is arranged to determine whether the cash payment is a good payment based on the risk assessment and in response to indication of receipt of the cash payment. The merchant interface is arranged to release the cash payment to the merchant in response to a determination that the cash payment is a good payment.

The risk manager can further include a comparator to initiate a comparison of the received non-confidential purchaser information with stored database information. The risk manager can further include an internal risk communications database in which at least a portion of the stored database information is stored. The comparator can compare the received non-confidential purchaser information with information stored in the internal risk communications database.

The risk manager can further include a risk communications interface in communication with at least one external risk analysis provider having an external database for performing part of the risk assessment. The comparator can compare the received non-confidential purchaser information with information stored at the at least one external risk analysis provider.

In a yet further aspect, the present invention provides an authorized cash payment administration system for processing a cash payment for an electronic purchase transaction, the cash payment administration system being in communication with a merchant and with a financial institution including: means for receiving a cash payment request associated with the cash payment for the electronic purchase transaction, the request including order information and non-confidential purchaser information; means for performing a risk assessment for the cash payment based on the order information and non-confidential purchaser information; means for determining whether the cash payment is a good payment based on the risk assessment and in response to receiving an indication of receipt of the cash payment from the purchaser; and means for releasing the cash payment to a merchant in response to a determination that the cash payment is a good payment.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flowchart illustrating a method of risk detection and assessment of a cash payment for an electronic purchase transaction according to an embodiment of the present invention.

FIG. 2 is a flowchart illustrating a method of risk detection and assessment of a cash payment for an electronic purchase transaction according to another embodiment of the present invention.

FIG. 3 is a block diagram illustrating a cash payment administration system according to an embodiment of the present invention.

FIG. 4 is a block and flow diagram showing interaction steps between a merchant, a cash payment administration system according to an embodiment of the present invention and a consumer.

FIG. 5 is a block and flow diagram illustrating a system and method for an authorized cash payment system according to an embodiment of the present invention.

FIG. 6 is a block and flow diagram illustrating a system and method for an authorized cash payment system according to another embodiment of the present invention.

### DETAILED DESCRIPTION

Generally, the present invention provides a system and methods which allow consumers to pay for ecommerce transactions through cash payment, such as online bill payment, and for merchants to determine payment risk and confirm that payments are not fraudulent. The system and methods do not rely on personal or confidential customer information relating to credit-cards, bank account routing information, date of birth and/or social security number.

A risk manager can perform risk assessment for the cash payment based on order information and non-confidential purchaser information included in a cash payment request. In response to receiving an indication of the cash payment from the purchaser, a determination is made whether the cash payment is a good payment based on the risk assessment. The cash payment is released to a merchant in response to a determination that the cash payment is a good payment.

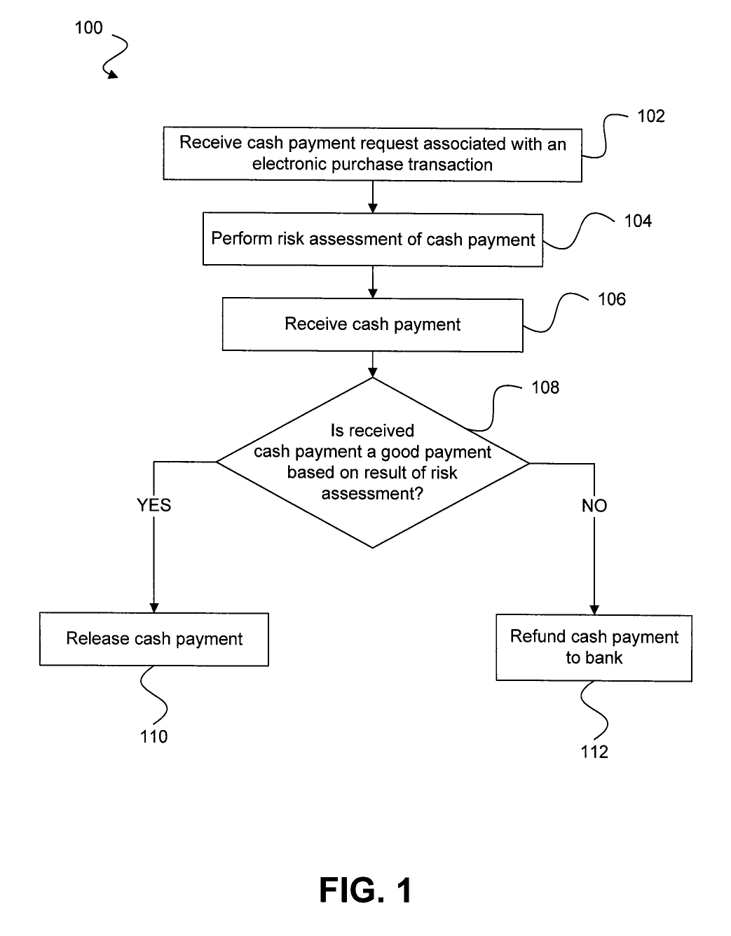

FIG. 1 is a flowchart illustrating a method 100 of risk detection and assessment of a cash payment for an electronic purchase transaction according to an embodiment of the present invention. In an embodiment, the method is performed by a cash payment administration system, such as a cash payment administrator or a cash payment processor. A computer readable memory can be provided storing statements and instructions for execution by a computer to perform the steps of methods described herein.

In step 102, a cash payment request is received, which is associated with the cash payment for the electronic purchase transaction. The cash payment request includes order information and non-confidential purchaser information, and can be received at a cash payment administration system. The non-confidential purchaser information does not include any personal or confidential customer information relating to credit-cards, bank account routing information, date of birth and/or social security number, or the like.

In step 104, a risk assessment is performed for the cash payment based on the order information and non-confidential purchaser information. The risk assessment can be performed at a risk manager within the cash payment administration system. The cash payment administration system can produce a cash payment risk score based on the risk assessment.

In step 106, the cash payment is received. Typically, the cash payment is received at a financial institution from the purchaser, such as in the case of an online bill payment. Receiving the cash payment can comprise receiving an indication at the cash payment administration system, from the financial institution, that the cash payment has been fulfilled or completed.

In step 108 a determination is made whether the cash payment is a good payment based on the risk assessment, such as based on a result of the risk assessment. Step 108 is performed in response to receiving an indication of receipt of the cash payment from the purchaser. In step 110, the cash payment is released to a merchant in response to a determination that the cash payment is a good payment. Releasing the cash payment to the merchant can include applying the cash payment to the electronic purchase transaction.

In step 112, the cash payment is refunded in response to a determination that the cash payment is not a good payment. For example, the cash payment can be refunded to a financial institution from which the cash payment originated.

Step 104 of performing the risk assessment can include determining a purchaser profile based on the received order information and non-confidential purchaser information. The purchaser profile can be based on a determination of whether the cash payment fits a normal payment pattern for a particular merchant, or for a particular type of electronic purchase transaction. The purchaser profile can also be based on past cash payment history, or other payment history of electronic purchase transactions. The step 108 of determining whether the cash payment is a good payment can include comparing the determined purchaser profile to a stored trustworthy purchaser profile to determine if the purchaser is a trusted purchaser. This can include, for example, determining trustworthiness based on average household income in the area surrounding the purchaser's address.

Step 104 can further include determining accuracy of the received purchaser information. Determining accuracy of the received purchaser information can include initiating a comparison of the received purchaser information with stored database information. For example, the cash purchase administration system can be in communication with one or a plurality of third party databases to verify accuracy of the received purchaser information. Determining accuracy of the received purchaser information can include, for example, verifying whether a provided phone number is associated with a provided shipment address.

The method of FIG. 1 can further include determining whether the purchaser information is fraudulent. This additional step can be part of step 104 of performing the risk assessment for the cash payment, or can be part of step 108 of determining whether the cash payment is a good payment. The determination of whether the purchaser information is fraudulent can be performed similar to the determination of accuracy of the received purchaser information. For example, providing a post office box as a shipment address can trigger a flag that the purchaser information may be fraudulent. Providing a cellular/mobile telephone number that is known to be a disposable phone can also be a trigger that the purchaser information may be fraudulent. The purchaser information can also be compared to stored “blacklist” information relating to historical cash payments that were refused, or multiple electronic purchase transactions being placed for the same item, or unusually large payment values for a particular order type or merchant.

In some cases, such as when the cash payment for the electronic purchase transaction exceeds a high payment value, additional cash payment risk assessment is desired. Therefore, for a high cash payment value determining whether the cash payment is a good payment further includes verifying an account holder name associated with the cash payment. For a high cash payment value, determining whether the cash payment is a good payment can be based on a payment source associated with the cash payment.

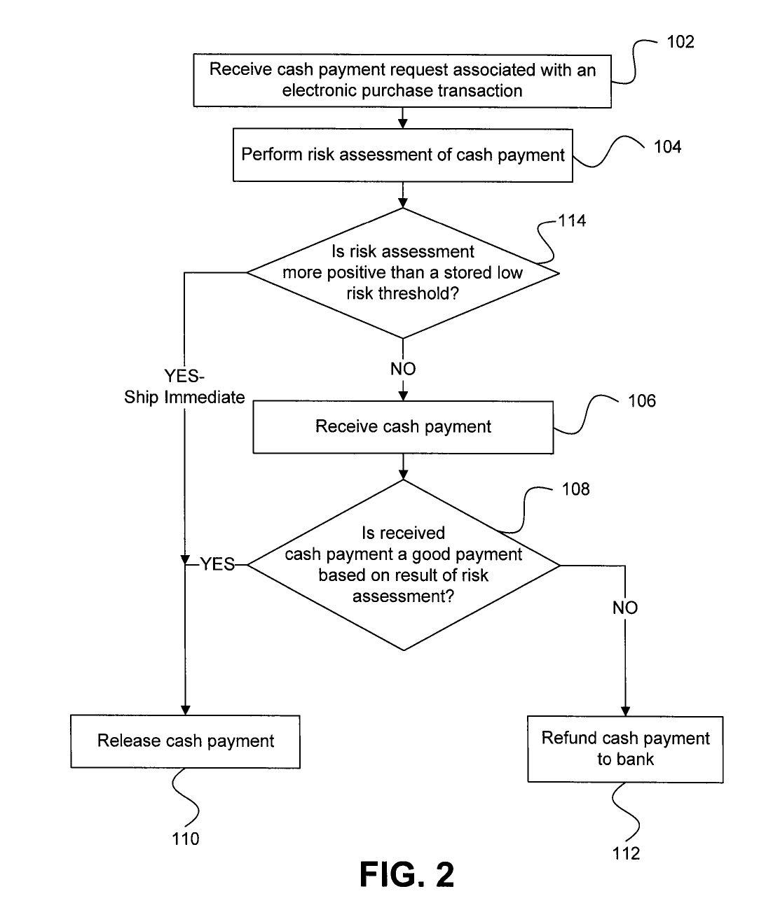

FIG. 2 is a flowchart illustrating a method of risk detection and assessment of a cash payment for an electronic purchase transaction according to another embodiment of the present invention. This embodiment relates to situations where it can be advantageous to immediately ship an order before confirming receipt of the cash payment, in anticipation of a good payment. Compared to FIG. 1, the method of FIG. 2 further includes step 114 of determining whether the risk assessment is more positive than a stored low risk threshold. The cash payment is then released prior to receiving the cash payment and in response to a determination that the risk assessment is more positive than the stored low risk threshold.

Determining that the risk assessment is more positive than a stored low risk threshold can be based on a purchaser's profile, or on the risk associated with the electronic purchase transaction. Determining that the risk assessment is more positive than the stored low risk threshold can be based on the electronic purchase transaction being made through a trusted merchant.

In embodiments of the invention, each merchant that enables receipt of cash payments, such as online bill payments, for ecommerce transactions is configured in the system through the system admin. Each configuration can include merchant credentials and risk thresholds to be applied to their orders. The thresholds can include average cash payment value, low cash payment limit and high cash payment limit. In an embodiment, the thresholds can include average order value (AOV).

In an embodiment, a merchant can be configured as a “Master-Merchant” with the ability to submit orders for “Sub-Merchants” that have not been configured on the system. These sub-merchants use the credentials and risk thresholds of the master-merchant and also provide various pieces of sub-merchant contact information (sub-merchant contact name, phone, email, URL). Therefore, if a master merchant is tagged as a trusted merchant, the sub-merchant can also be tagged as a trusted merchant. Alternatively, a sub-merchant's profile can be based on a master merchant's profile and subsequently modified based on cash payment history, etc. If desired, a sub-merchant's profile can be disassociated from a master merchant's profile in response to detection that the sub-merchant's profile has diverged past a threshold value from the master merchant's profile in relation to one or more configuration criteria.

In an embodiment of the invention, the merchant will only ship goods when the system indicates that the payment is good.

In a traditional model, a consumer accesses a merchant website and selects the goods or service they wish to purchase. According to embodiments of the present invention, in the shopping cart, or at checkout, the consumer can select a cash payment option, such as online bill payment, as the payment method.

Alternatively, the consumer can contact a call center to place an order and request to use cash payment, such as online bill payment, as the pay method.

The merchant's shopping cart will submit the consumer and order information to the system using merchant interface. The information is processed through the risk manager, or risk interface, in order to return an authorization, to the merchant, based on the risk assessment of the cash payment.

As described above in relation to FIG. 2, embodiments of the present invention can enable merchants to instantly ship select orders. In an embodiment, a purchaser's electronic purchase transaction, or order, must qualify for such instant shipment. A determination of qualification can be made based on: prior purchase history with the cash payment administration system; prior purchase history with the merchant; low fraud score based on risk assessment; and/or low risk score based on risk assessment. A cash payment with a low risk score can be shipped immediately. A cash payment with an unknown or inconclusive risk score can be designated to ship under review. For a cash payment with a high risk score, wait for payment before completing the transaction or order. If there is confirmed fraud, the transaction is declined.

The overall process flow between the merchant and the cash payment administrator (such as eBillme™) can be described as follows. The merchant submits order information to the cash payment administrator for pre-authorization. The cash payment administrator detects and assesses cash payment risk, and can produce a cash payment risk score. The cash payment administrator then returns a cash payment risk authorization, which can include: ship; ship under review; wait; or decline. The merchant presents the ship or wait acceptance screen to the purchaser. The merchant submits electronic purchase transaction order information and non-confidential purchaser information to the cash payment administrator for authorization. The merchant updates the electronic purchase transaction order in their system based on the following: ship—fulfill order; ship under review—order is pending until authorization is received from the cash payment administrator; wait—order is pending until payment notification is received; or decline—not authorized to use cash payment for the electronic purchase transaction. The merchant fulfills orders on shipping authorization. The cash payment administrator can settle funds for all shipped orders.

According to an embodiment of the present invention, risk scoring or risk assessment can be based on risk assessment of the merchant, purchaser and/or the electronic purchase transaction, or order. Manual order reviews may be conducted by the cash payment administrator. The risk score, or risk assessment, can be based on one or more of the following criteria: IP country (out/risk); email (private, public); IP/shipping/billing distance; open proxy (common, hiding, known bad); billing and shipping match; address verification on name, billing/shipping, telephone; cash payment amount within risk limit (average cash payment value+credit limit); shipping method (ground, express); velocity (within/across merchants); prior shipped unpaid/paid orders; account holder name on payment; and merchant customer ranking (existing good, existing bad, new).

A “ship” cash payment risk authorization is issued when the cash payment is approved. If there is detected risk in the cash payment amount, shipping method, velocity, failed AVS, proxy, billing/shipping mismatch, or an indication that review is required, a “ship under review” cash payment risk authorization can be issued. In the embodiment in which shipment prior to payment is possible, a “decline” cash payment risk authorization can be issued under such circumstances. A “decline” cash payment risk authorization can be issued in response to a match in a negative database, or based on the country of origin of the purchaser or transaction.

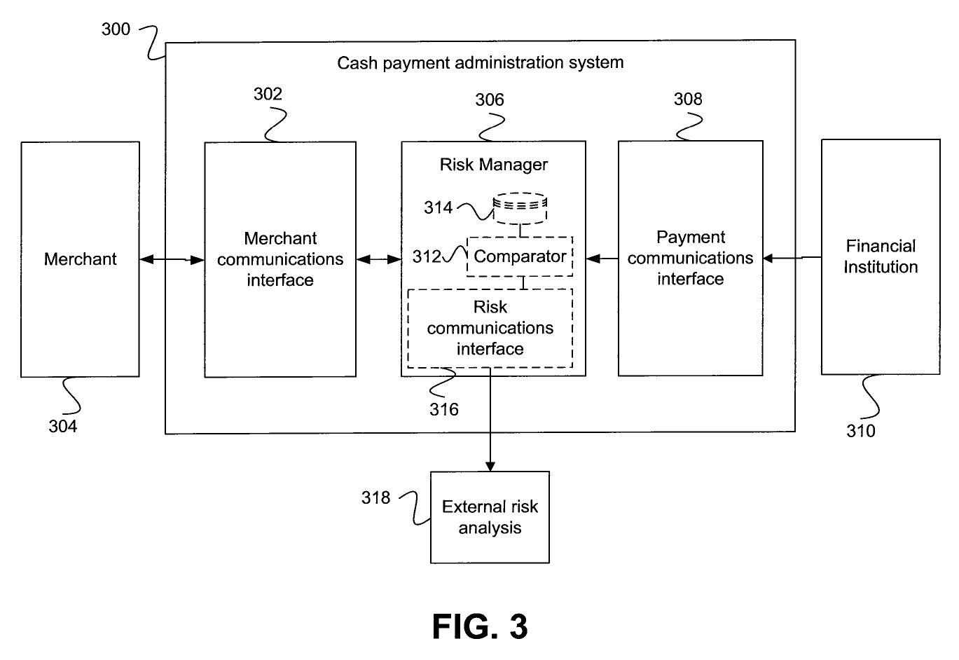

FIG. 3 is a block diagram illustrating a cash payment administration system 300 according to an embodiment of the present invention. The cash payment administration system 300 is for processing a cash payment for an electronic purchase transaction. The cash payment administration system is in communication with a merchant and with a financial institution. A merchant communications interface 302 is arranged to receive, from a merchant 304, a cash payment request associated with the cash payment, the request including order information and non-confidential purchaser information. A risk manager 306 is arranged to perform a risk assessment for the cash payment based on the order information and non-confidential purchaser information. A payment communications interface 308 is arranged to receive, from a financial institution 310, an indication of receipt of the cash payment from the purchaser. The risk manager 306 determines whether the cash payment is a good payment based on the risk assessment and in response to indication of receipt of the cash payment. The merchant interface 302 releases the cash payment to the merchant in response to a determination that the cash payment is a good payment.

In an embodiment, the risk manager can include a comparator 312 to initiate a comparison of the received non-confidential purchaser information with stored database information. The risk manager 306 can include an internal risk communications database 314 in which at least a portion of the stored database information is stored. The comparator 312 can compares the received non-confidential purchaser information with information stored in the internal risk communications database 314.

The risk manager 306 can further include a risk communications interface 316 in communication with at least one external risk analysis provider 318 having an external database for performing part of the risk assessment. The comparator 312 can compare the received non-confidential purchaser information with information stored in the external database at the at least one external risk analysis provider 318.

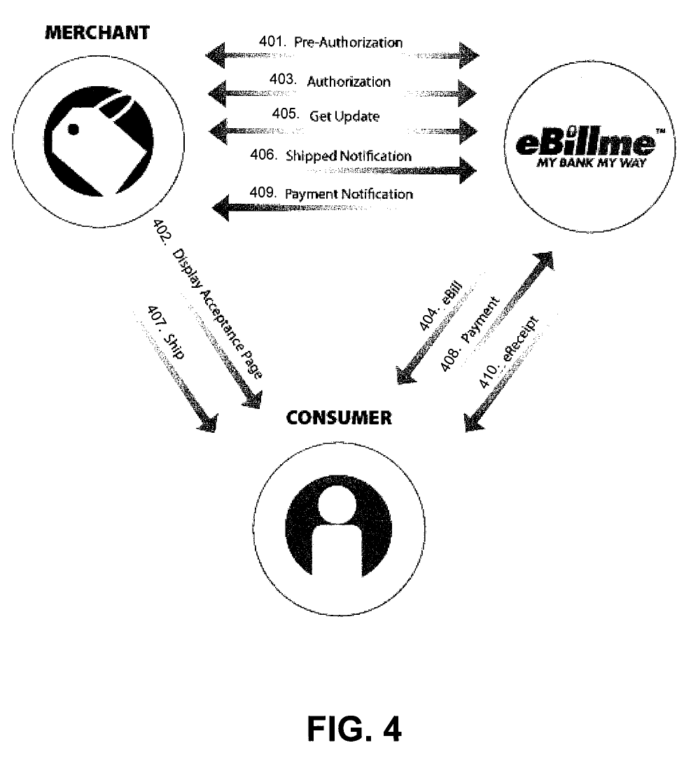

FIG. 4 is block and flow diagram illustrating a system and method for an authorized cash payment system according to an embodiment of the present invention. At step 401, pre-authorization occurs between the merchant and a cash payment administrator, such as eBillme™. At step 402, the merchant displays acceptance page to the consumer. At step 403, authorization occurs between the cash payment administrator and the merchant. At step 404, an ebill is sent from the cash payment administrator to the consumer. At step 405, an update occurs between the cash payment administrator and the merchant. At step 406, the merchant sends shipping notification to the cash payment administrator. At step 407, the purchased item(s) are shipped from the merchant to the consumer. At step 408, the consumer pays the ebill to the cash payment administrator, which in turn, notifies the merchant of the payment at step 409. At step 410, the cash payment administrator sends an e-receipt to the consumer.

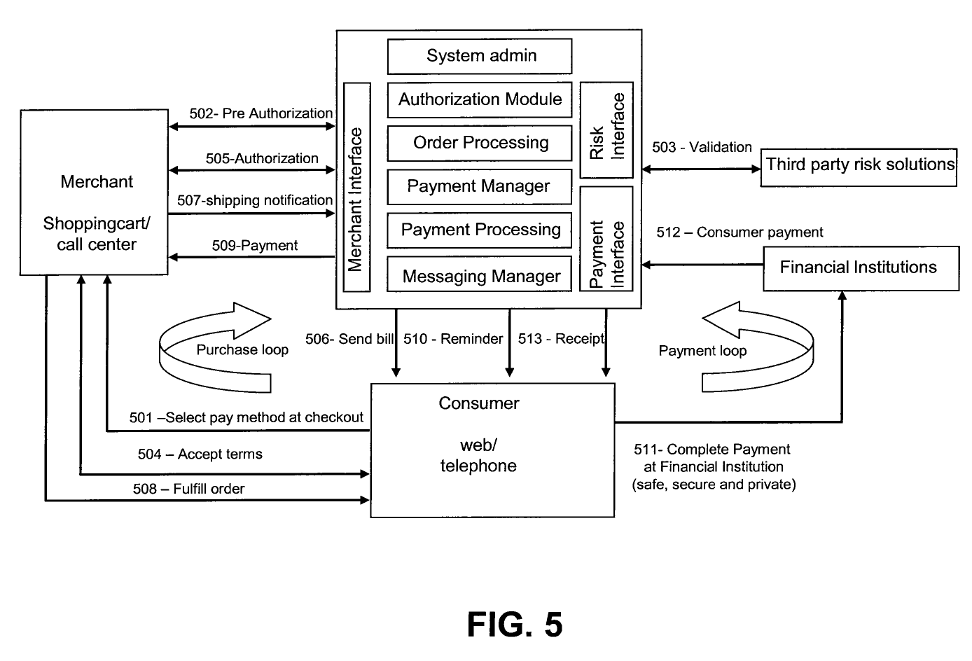

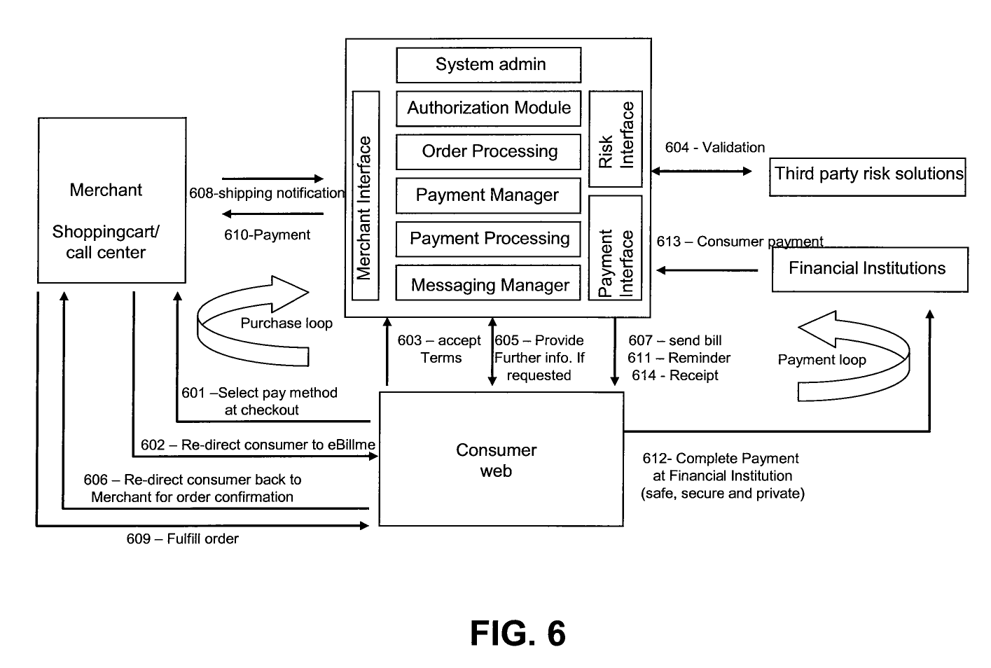

Depending on the embodiment or version of the system the merchant has implemented, the consumer can follow one of two different paths when placing an order with the eBillme system, described below in relation to FIG. 5 and FIG. 6.

FIG. 5 is a block and flow diagram illustrating a system and method for an authorized cash payment system according to an embodiment of the present invention using back-end pre-authorization and authorization. In this embodiment, the merchant is collecting & presenting the required customer and order information directly to the consumer's web browser. The merchant is communicating with the eBillme system directly in the back-end. The eBillme system assesses risk based on information provided by the merchant in the initial submit order.

At step 501 in FIG. 5, the consumer places an order from a merchant via phone or the web, and selects the method of payment through a cash payment administrator, such as eBillme™. At step 502 pre-authorization occurs between the merchant and a merchant interface at the cash payment administrator. At step 503, validation occurs between a risk interface at the cash payment administrator and third party risk solutions. The merchant displays the terms and conditions applicable to the consumer. At step 504 acceptance of terms and conditions occurs between the consumer and the merchant. Authorization occurs between the merchant and the cash payment administrator at step 505. At step 506 a bill is sent to the consumer from the cash payment administrator. At step 507 the merchant send shipping notification to the cash payment administrator. At step 508, the order is fulfilled between the merchant and the consumer. At step 509 the cash payment administrator processes payment to the merchant. If the bill sent to the consumer is not yet paid, the cash payment administrator sends a reminder to the consumer at step 510. At step 511 the consumer completes payment of the bill at a financial institution in a safe secure and private manner. At step 512, payment of the bill is received from the financial institution at a payment interface of the cash payment administrator. At step 513 a receipt is sent to the consumer from the cash payment administrator.

FIG. 6 is a block and flow diagram illustrating a system and method for an authorized cash payment system according to another embodiment of the present invention using front-end pre-authorization and authorization. In this embodiment, the merchant passes the consumer's web browser to the eBillme™ system when the order request is initially made. The eBillme system performs varying levels of risk assessment and consumer information collection in real-time to assess risk. The front-end flow provides the added flexibility of gather more information from the consumer, if required, than was available in the initial submit-order request from the merchant.

At step 601 in FIG. 6, the consumer places an order from a merchant using the web, and selects the method of payment through a cash payment administrator, such as eBillme™. At step 602, the consumer is re-directed to the cash payment administrator (ebillme). At step 603, the terms and conditions are accepted between the consumer and the cash payment administrator. At step 604, validation occurs between a risk interface at the cash payment administrator and third party risk solutions. At step 605, further information is provided between the consumer and the cash payment administrator, if needed. At step 606, the consumer is redirected back to the merchant for order confirmation. At step 607, a bill is sent from the cash payment administrator to the consumer. At step 608, the merchant sends shipping notification to the cash payment administrator. The order is fulfilled between the consumer and the merchant at step 609. The merchant is paid by the cash payment administrator at step 610. If the bill sent to the consumer is not paid by the consumer yet, the cash payment administrator sends a reminder to the consumer at step 611. At step 612, the consumer pays the bill at a financial institution in a safe, secure, and private manner. At step 613, payment of the bill is received from the financial institution at a payment interface of the cash payment administrator. At step 614, a receipt is sent to the consumer by the cash payment administrator.

A risk manager according to an embodiment of the present invention can perform an API call to one or more third party risk platforms in order to validate individual pieces of the consumer and order information. For example, a typical third party validation can include an address verification tool which will confirm if the name, address and billing information match. Another third party tool can confirm that the geographical identity information matches: such as IP address proximity to billing and/or shipping and not being from a restricted country. The data and results are then analyzed along with historical data to determine the authorization results which can include: expedite shipment immediately; ship upon payment receipt; further review required; declined. Along with the authorization results, the system can return the URL for the acceptance screen.

Based on the results of authorization, the merchant (in the case of the back-end pre-authorization) or the eBillme system (in the case of front-end pre-authorization) preferably displays the terms and conditions applicable to the cash payment authorization. Final processing is completed once the risk manager has made an assessment. Once the consumer has accepted the terms and conditions the merchant sends the final authorization request to the system for processing. The consumer account is created if one did not exist before, and the order is processed and stored.

The merchant displays an order confirmation screen to the consumer with static cash bill payment instructions and dynamic order information. The system messaging manager sends a bill to the consumer instructing them how to immediately make their cash payment, such as online bill payment.

In one embodiment of the invention, the merchant submits a ship notification message to the system for an order which received ship authorization. Upon receipt of the ship notification, the system performs payment processing to determine if the order has been paid, and if the shipping amount is within the authorization limit for that cash payment. The merchant then fulfills the consumer order. In many cases the consumer payment may be received by the system before the ship notification is received from the merchant.

In an embodiment, the system updates the system with a payment, sends a payment notification to the merchant and credit file to settle funds directly in to the merchant's account before the consumer payment is received by the system.

In an embodiment, the system updates the database with the shipping notification but not settle funds to the account if the consumer's payment has already been sent to the merchant because it was received before the ship notification.

In an embodiment of the system, the payment manager checks for orders which have not been paid and notifies the messaging manager to send an electronic bill reminder to the consumer.

The consumer can proceed to their banking portal to make an online bill payment to the payee specified on the bill for the amount of their purchase.

The payment flows from the consumer bank account to the system bank account via one of many banking networks (RPPS, ePAY Checkfree, Metavante, etc.). The payment processing parses the banking information and updates the consumer account and order(s) with the payment information.

In one embodiment of the system, the consumer makes payments via non-online bill payment methods (e.g. walk-in payments, checks, wire transfers, and money orders).

Once the cash payment is received the messaging manager will send the consumer an electronic receipt.

An embodiment of the invention, the merchant ships goods on cash payment authorization from the system prior to receiving payment from the consumer.

In an embodiment of the invention, depending on the authorization results, the merchant will ship the goods immediately or wait for the consumer's payment.

In an aspect, the present invention provides a system which allows consumers to pay for ecommerce transactions by cash payment, such as through online bill payment, and for merchants to determine payment risk and immediately expedite shipment or to confirm payments are not fraudulent without personal or confidential customer information relating to credit-cards and/or bank account routing information. The system can include:
connections to merchants to receive consumer and order information
connections to a plurality of 3rd parties to verify consumer and order information
a database containing historical consumer and payment information
a risk assessment engine that returns an authorization, such as:
   i. immediately expedite shipment
   ii. ship upon payment receipt
   iii. further review
   iv. decline
      for the purpose of determining the order and payment handling.
connections to merchants to deliver custom messaging to consumers
connections to merchants to receive shipping notifications
connections to merchants to receive order updates, cancellations, and refund notifications
connections to the banks to receive consumer payment information
payment processing to provide settlement of guaranteed funds to merchants for shipped orders
merchant configuration to set risk thresholds to be applied to each payment
messaging manager to deliver electronic bills, reminders, and receipts to consumers
management of bad payments
merchant administration portal

The risk assessment engine can be configurable and can operate in real-time or batch-mode supporting least-cost, least-time assessment.

The system can apply not only to online bill payments, but also to any non-credit cash payment option including:
walk-in payments
checks
wire-transfers
money-order

In another aspect, the present invention provides a method supporting authorization of consumer orders, to be paid with cash payment such as online bill payment, wherein the results determine order handling and payment processing. The method can include the following steps:
creating a merchant account
receiving an authorization request from the merchant that includes consumer and order information from the merchant
determining order risk
returning an authorization to merchant
sending an electronic bill to the consumer
receiving a shipping notification from a merchant
sending payment and settlement information to a merchant
sending an electronic reminder and receipt to the consumer
receiving consumer payment from a bank
managing unpaid orders

Cash payment risk from consumer and order information can be determined based on:
geographical identification information
address verification service
billing and shipping address comparison
historical consumer, order, and payment information across merchants
merchant's order rating
credit limit
shipping method
items purchased

In high payment value situations, payment risk can preferably be determined from payment information using:
account holder name
payment source

The step of creating a merchant account can include configuring threshold values, such as:
average payment value
low payment limit
high payment limit

The system can manage unpaid orders by:
identifying fraudulent orders
sending one or more electronic reminders
flagging manual order review
moving payments to collections: and/or
adding consumer and payment information to negative database

Determining whether a consumer's payment will be applied to a merchant based on the previously calculated payment risk to a merchant based on rules for handling:
exact payments
underpayments and overpayments
duplicate payments: and/or
payments to wrong accounts

In an embodiment, the present invention provides a method of risk detection and assessment for a deferred payment electronic purchase transaction, comprising: receiving, at a merchant server, a cash purchase request, the request including order information and non-confidential purchaser information; initiating, at a risk manager, a plurality of validation steps based on verification of the order information and non-confidential purchaser information; correlating the results of the plurality of validation steps to generate a cash payment authorization result; displaying, to the purchaser, a message representative of the cash payment authorization result; and sending the bill to the purchaser.

In another embodiment, the present invention provides a method of risk detection and assessment for a deferred payment electronic purchase transaction, comprising: conducting pre-authorization in response to receipt of a merchant order request; performing validation in conjunction with third party risk solutions; generating an authorization result; sending a bill to the consumer; authorizing payment in response to receipt of a shipping notification from the merchant; communicating with the consumer to complete the payment at a financial institution; and issuing a receipt to the consumer in response to receipt of a consumer payment confirmation from the financial institution.

In a further embodiment, the present invention provides a system for risk detection and assessment for a deferred payment electronic purchase transaction, comprising: a merchant server arranged to receive a cash payment request for a cash payment associated with an electronic purchase transaction, the request including order information and non-confidential purchaser information; a risk assessor arranged to initiate a plurality of validation steps based on the order information and non-confidential purchaser information and to correlate the results of the plurality of validation steps to generate a deferred payment authorization result; and an order processor arranged to process the cash payment.

In a yet further embodiment, the present invention provides a system for ecommerce purchase transactions using cash payment including a risk assessment engine that returns an authorization for the purpose of determining order shipment and payment handling prior to receipt of payment and in the absence of access to confidential information or financial information relating to the purchaser.

In the above description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of risk detection and assessment of a cash payment for an electronic purchase transaction, comprising:
receiving, at a cash payment administration system, a cash payment request associated with the cash payment for the electronic purchase transaction, the request including order information and non-confidential purchaser information;
performing, at a risk manager within the cash payment administration system, a risk assessment for the cash payment based on the order information and non-confidential purchaser information;
in response to receiving an indication of receipt of the cash payment from the purchaser, determining, at the risk manager, whether the cash payment is a good payment based on the risk assessment;
releasing the cash payment to a merchant in response to a determination that the cash payment is a good payment.

2. The method of claim 1 wherein performing the risk assessment comprises determining a purchaser profile based on the received order information and non-confidential purchaser information.

3. The method of claim 2 wherein determining whether the cash payment is a good payment comprises comparing the determined purchaser profile to a stored trustworthy purchaser profile to determine if the purchaser is a trusted purchaser.

4. The method of claim 1 wherein performing the risk assessment comprises determining accuracy of the received non-confidential purchaser information.

5. The method of claim 4 wherein determining accuracy of the received non-confidential purchaser information includes initiating a comparison of the received non-confidential purchaser information with stored database information.

6. The method of claim 1 wherein determining whether the cash payment is a good payment comprises determining whether the non-confidential purchaser information is fraudulent.

7. The method of claim 1 wherein releasing the cash payment to the merchant comprises applying the cash payment to the electronic purchase transaction.

8. The method of claim 1 further comprising refunding the cash payment in response to a determination that the cash payment is not a good payment.

9. The method of claim 8 comprising refunding the cash payment to a financial institution from which the cash payment originated.

10. The method of claim 1 wherein determining whether the cash payment is a good payment comprises verifying an account holder name associated with the cash payment.

11. The method of claim 1 wherein determining whether the cash payment is a good payment is based on a payment source associated with the cash payment.

12. The method of claim 1 wherein releasing the cash payment is performed prior to receiving the cash payment and in response to a determination that the risk assessment is more positive than a stored low risk threshold.

13. A computer readable memory storing statements and instructions for execution by a computer to perform the method of claim 1.

14. A cash payment administration system for processing a cash payment for an electronic purchase transaction, the cash payment administration system being in communication with a merchant and with a financial institution, comprising:
a merchant communications interface arranged to receive, from the merchant, a cash payment request associated with the cash payment, the request including order information and non-confidential purchaser information;
a risk manager arranged to perform a risk assessment for the cash payment based on the order information and non-confidential purchaser information; and
a payment communications interface arranged to receive an indication of receipt of the cash payment by the financial institution from the purchaser;
the risk manager arranged to determine whether the cash payment is a good payment based on the risk assessment and in response to indication of receipt of the cash payment;
the merchant interface arranged to release the cash payment to the merchant in response to a determination that the cash payment is a good payment.

15. The cash payment administration system of claim 14 wherein the risk manager further comprises a comparator to initiate a comparison of the received non-confidential purchaser information with stored database information.

16. The cash payment administration system of claim 15 wherein the risk manager further comprises an internal risk communications database in which at least a portion of the stored database information is stored, and wherein the comparator compares the received non-confidential purchaser information with information stored in the internal risk communications database.

17. The cash payment administration system of claim 15 wherein the risk manager further comprises a risk communications interface in communication with at least one external risk analysis provider having an external database for performing part of the risk assessment, and wherein the comparator compares the received non-confidential purchaser information with information stored at the at least one external risk analysis provider.

18. An authorized cash payment administration system for processing a cash payment for an electronic purchase transaction, the cash payment administration system being in communication with a merchant and with a financial institution, comprising:
means for receiving a cash payment request associated with the cash payment for the electronic purchase transaction, the request including order information and non-confidential purchaser information;
means for performing a risk assessment for the cash payment based on the order information and non-confidential purchaser information;
means for determining whether the cash payment is a good payment based on the risk assessment and in response to receiving an indication of receipt of the cash payment from the purchaser; and
means for releasing the cash payment to a merchant in response to a determination that the cash payment is a good payment.
